(19) United States
(12) Patent Application Publication
(10) Pub. No.: US 2025/0133378 A1
(43) Pub. Date: Apr. 24, 2025

(54) VEHICLE OPERATION SYSTEM

(71) Applicant: TOYOTA JIDOSHA KABUSHIKI KAISHA, Toyota-shi (JP)

(72) Inventors: Tatsuya SUGANO, Sunto-gun (JP); Koji MORITA, Gotemba-shi (JP); Hiroya CHIBA, Fuji-shi (JP)

(73) Assignee: TOYOTA JIDOSHA KABUSHIKI KAISHA, Toyota-shi (JP)

(21) Appl. No.: 18/808,332

(22) Filed: Aug. 19, 2024

(30) Foreign Application Priority Data
Oct. 19, 2023 (JP) 2023-180500

(51) Int. Cl. H04W 4/44; G08G 1/017; H04L 67/12; H04W 4/021

(52) U.S. Cl. CPC H04W 4/44; G08G 1/017; H04L 67/12; H04W 4/022

(57) ABSTRACT

A vehicle operation system performs an operation of a target vehicle through communication by transferring an authority to operate the target vehicle from a user of the target vehicle. First, the vehicle operation system establishes the communication with a first vehicle while the first vehicle is traveling in an authority transition zone prior to a vehicle stop position where the user gets off the target vehicle. Next, the vehicle operation system starts a vehicle identification process for identifying the first vehicle as the target vehicle while the first vehicle is traveling in a vehicle identification zone prior to the vehicle stop position. After the vehicle identification process is completed, the vehicle operation system completes the transfer of the authority from the user.

### CROSS-REFERENCE TO RELATED APPLICATION

The present disclosure claims priority to Japanese Patent Application No. 2023-180500, filed on Oct. 19, 2023, the contents of which application are incorporated herein by reference in their entirety.

### TECHNICAL FIELD

The present disclosure relates to a technique for operating a target vehicle through communication.

### BACKGROUND ART

In recent years, various functions for operating a target vehicle through communication have been considered as services for vehicles. For example, one of such functions is automated valet parking (AVP) in a parking lot. Patent Literature 1 discloses a conventional general AVP system. Patent Literature 1 discloses that, after a user (passenger) stops a vehicle at a drop-off position, communication establishment, authentication, etc. are performed in response to the operation of a terminal device at the drop-off position.

In addition, the following Patent Literatures 2 and 3 are documents showing the technical level of the present technical field.

### List of Related Art

Patent Literature 1: JP 2019160086 A

Patent Literature 2: JP 2020187624 A

Patent Literature 3: JP 2023050922 A

### SUMMARY

In order to start the operation of a target vehicle in the function of AVP or the like, it is necessary to complete a procedure for transferring authority (operation authority) to operate the target vehicle from the user of the target vehicle to the system. Conventionally, as disclosed in Patent Literature 1, the procedure related to the transfer of the operation authority is performed after a vehicle is stopped at a drop-off position. On the other hand, in order to transfer the operation authority, at least establishment of communication with the target vehicle and completion of identification of the target vehicle (identification can also be referred to as authentication) are required, and these procedures require a certain amount of time. Therefore, in the conventional technique, a vehicle that stops at a drop-off position continues to stop there for a while until the transfer of the operation authority is completed. It is not preferable that a vehicle occupies a space for a long time because it hinders efficient traffic.

An object of the present disclosure is, in view of the above problems, to suppress the occurrence of a situation in which efficient traffic is hindered when an operation authority is transferred with respect to a technique for operating a target vehicle through communication.

One aspect of the present disclosure is directed to a vehicle operation system for performing an operation of a target vehicle through communication by transferring an authority to operate the target vehicle from a user of the target vehicle.

The vehicle operation system comprises one or more processors.

The one or more processors are configured to:
establish the communication with a first vehicle while the first vehicle is traveling in an authority transition zone prior to a vehicle stop position where the user gets off the target vehicle;
start a vehicle identification process for identifying the first vehicle as the target vehicle while the first vehicle is traveling in a vehicle identification zone prior to the vehicle stop position; and
after the vehicle identification process is completed, complete the transfer of the authority from the user.

According to the present disclosure, communication with the first vehicle is established at a time point before the first vehicle reaches the vehicle stop position. This can achieve a state where the communication with the first vehicle has been established when the first vehicle reaches the vehicle stop position. Furthermore, according to the present disclosure, the vehicle identification process is started at a time point before the first vehicle reaches the vehicle stop position. This can achieve, when the first vehicle reaches the vehicle stop position, a state where the identification of the target vehicle has been completed or where a part of the vehicle identification process has been performed. In this way, it is possible to shorten the time for which the target vehicle stops at the vehicle stop position with respect to the transition of the operation authority. As a result, it is possible to suppress the occurrence of a situation in which efficient traffic is hindered.

### BRIEF DESCRIPTION OF DRAWINGS

FIG. 1 is a conceptual diagram for explaining an AVP system;

FIG. 2 is a conceptual diagram for explaining an outline of an operation authority transition process according to the present embodiment;

FIG. 3 is a conceptual diagram for explaining an outline of a vehicle identification process by an action-based identification method;

FIG. 4A is a conceptual diagram for explaining an outline of one additional processing according to the present embodiment;

FIG. 4B is a conceptual diagram for explaining an outline of one additional processing according to the present embodiment;

FIG. 5 is a diagram showing an example of a processing flow in a vehicle operation system according to the present embodiment; and

FIG. 6 is a diagram showing an example of a hardware configuration of the vehicle operation system according to the present embodiment.

### DETAILED DESCRIPTION

### 1. Vehicle Operation System

The vehicle operation system according to the present embodiment is a system that provides a function of performing an operation of a target vehicle through communication. As one of vehicle operation systems, there is an AVP system that provides automated valet parking (AVP) in a parking lot. The AVP is a function of automatically performing the entry and exit of a target vehicle in a parking lot without depending on a user's operation.

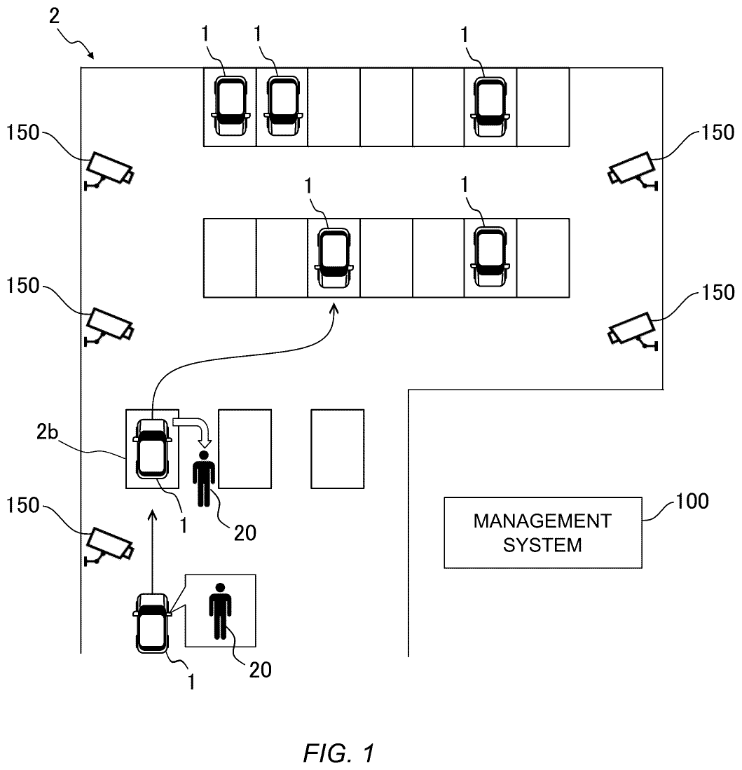

FIG. 1 is a conceptual diagram for explaining an AVP system. The management system 100 manages the AVP in the parking lot 2. A sensor 150 that detects the position and state of each vehicle 1 in the parking lot 2 is installed in the parking lot 2. The management system 100 manages information of the parking lot 2 and each vehicle 1 based on detection information acquired using the sensor 150. The parking lot 2 is provided with a vehicle stop position 2b for which the target vehicles are required to stop. The user 20 stops the vehicle 1 (target vehicle) to be parked at the vehicle stop position 2b. The user 20 gets off the vehicle 1 (target vehicle) at the vehicle stop position 2b. After confirming that the user 20 has gotten off the train, the management system 100 starts AVP for the target vehicle stopping at the vehicle stop position 2b. Specifically, the management system 100 transmits command information such as a parking position and a traveling route to the target vehicle through communication based on the management data related to the parking lot 2 and each vehicle 1. The AVP is implemented by controlling the target vehicle according to the command information received by the control system of the target vehicle.

In this way, the AVP system is configured by the management system 100 and the control system of the target vehicle cooperating with each other. After confirming that the user 20 has got off at the vehicle stop position 2b, the management system 100 starts AVP for the target vehicles stopping at the vehicle stop position 2b. Such a configuration is also applicable to a vehicle operation system that provides other functions. The vehicle stop position 2b may be a position where the user 20 gets off the target vehicle in order to receive the provision of the function by the vehicle operation system.

In the vehicle operation system, in order for the management system 100 to start the operation of the target vehicle, it is necessary to transfer the authority to operate the target vehicle (operation authority) from the user 20 to the management system 100. On the other hand, the transfer of the operation authority requires at least the establishment of communication with the target vehicle and the completion of identification (authentication) of the target vehicle. The identification of the target vehicle is necessary to confirm that the vehicle 1 to be provided with the function is the vehicle 1 (target vehicle) of the authorized user 20. By identifying the target vehicle, the reliability and safety of the function are ensured. However, these procedures take some time. Therefore, in the related art (for example, the technique disclosed in Patent Literature 1), it is assumed that the vehicle 1 (target vehicle) continues to stop at the vehicle stop position 2b for a while from the start to the end of the procedure related to the transfer of the operation authority. However, it is not preferable that the vehicle 1 occupies a certain space for a long time because efficient traffic is hindered. For example, in the AVP, efficient vehicle loading of the vehicle 1 is hindered, and there is a concern that congestion of vehicles 1 waiting for loading may be caused.

In view of the above problem, the vehicle operation system according to the present embodiment can suppress the occurrence of a situation in which efficient traffic is hindered when the operation authority is transferred.

### 2. Operation Authority Transition Process

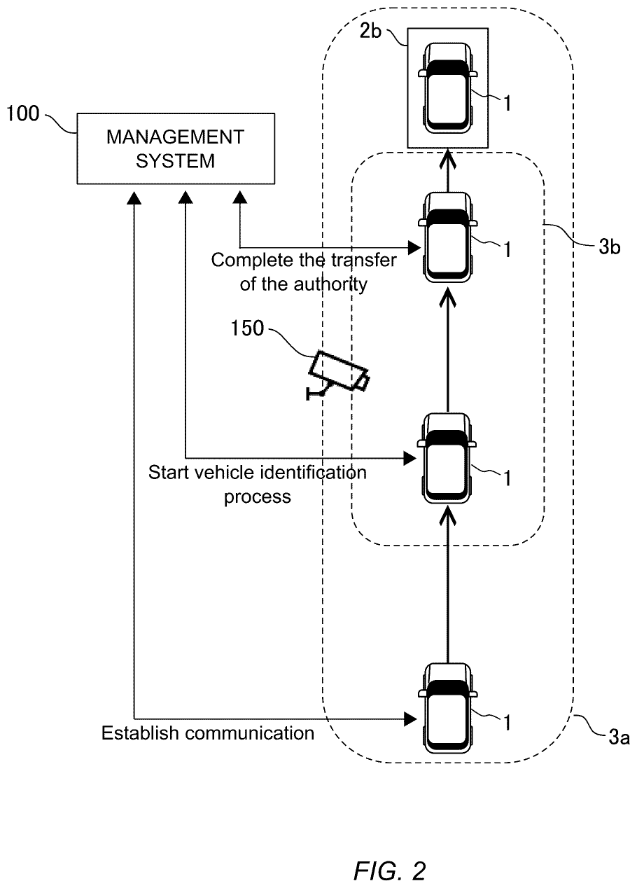

FIG. 2 is a conceptual diagram for explaining an overview of a process (hereinafter, referred to as an “operation authority transition process”) executed to transition the operation authority from the user 20 to the management system 100 in the vehicle operation system according to the present embodiment.

In the vehicle operation system according to the present embodiment, an authority transition zone 3a and a vehicle identification zone 3b having a certain range are provided before the vehicle stop position 2b. FIG. 2 shows an example of the authority transition zone 3a and the vehicle identification zone 3b. In FIG. 2, the vehicle identification zone 3b is included in the authority transition zone 3a. However, the positional relationship and the range of the authority transition zone 3a and the vehicle identification zone 3b may be appropriately determined according to the environment to which the present embodiment is applied. The authority transition zone 3a and the vehicle identification zone 3b may be provided as a virtual range in information process.

In the vehicle operation system according to the present embodiment, when the vehicle 1 (first vehicle) travels in the authority transition zone 3a, a procedure related to the transition of the operation authority is started. In particular, the management system 100 establishes communication (for example, a wireless local area network (LAN)) with the vehicle 1 while the vehicle 1 is traveling in the authority transition zone 3a.

On the other hand, when the vehicle 1 (first vehicle) travels in the vehicle identification zone 3b, the vehicle identification is started. The management system 100 starts a process (vehicle identification process) for identifying the vehicle 1 as a target vehicle while the vehicle 1 is traveling in the vehicle identification zone 3b. The vehicle identification process is typically performed using the sensor 150. Therefore, the vehicle identification zone 3b is typically set to be included in the detection range of the sensor 150.

Then, after the vehicle identification process is completed, the management system 100 completes the transfer of the operation authority from the user 20. In particular, the management system 100 may be configured to complete the vehicle identification process before the vehicle 1 reaches the vehicle stop position 2b. Further, the management system 100 may be configured to complete the transfer of the operation authority from the user 20 before the vehicle 1 reaches the vehicle stop position 2b.

As described above, according to the present embodiment, the procedure related to the shift of the operation authority is started at a time point before the vehicle 1 reaches the vehicle stop position 2b. In particular, communication between the management system 100 and the vehicle 1 is established. Thus, when the vehicle 1 reaches the vehicle stop position 2b, the communication with the vehicle 1 can be established. Further, according to the present embodiment, the vehicle identification process is started at a time point before the vehicle 1 reaches the vehicle stop position 2b. Thus, when the vehicle 1 reaches the vehicle stop position 2b, the identification of the target vehicle is completed or a part of the car identification process is completed. In this way, according to the present embodiment, it is possible to shorten the time for which the target vehicle stops at the vehicle stop position 2b in relation to the shift of the operation authority. In addition, it is possible to suppress the occurrence of a situation in which efficient traffic is hindered.

In the present embodiment, the method of the vehicle identification process is not particularly limited. For example, as the vehicle identification process, a method of recognizing a license plate of the vehicle 1 using the sensor 150 (for example, a camera) and collating information of the recognized license plate to identify the vehicle is exemplified. When this method is adopted, since the establishment of communication is not required for the execution of the vehicle identification process, the vehicle identification zone 3b may be provided before the authority transition zone 3a. At this time, in the procedure related to the transfer of the operation authority in the authority transition zone 3a, it is confirmed that the vehicle identification is completed.

On the other hand, the present embodiment is particularly effective when a method that requires a certain amount of time for vehicle identification is employed. For example, in the present embodiment, it is possible to consider adopting a method (hereinafter, referred to as an “action-based identification method”) of instructing the vehicle 1 to execute an action and identifying a target vehicle based on whether or not an action recognized using the sensor 150 matches an expected action.

Here, the action can be defined by a combination of a device (means) for executing the action and an operation pattern of the device. Examples of the device that performs the action include a lighting device (a headlight, a brake light, a fog light, or the like), an in-vehicle illumination device, a horn, a direction indicator, a wiper, a door, a door window, an engine, and an electric motor. For example, one action is to flash the lights of the headlights in a specified pattern. For example, one of the actions is to sound the horn in a specified pattern. The action may include a request for a repetition of the motion pattern.

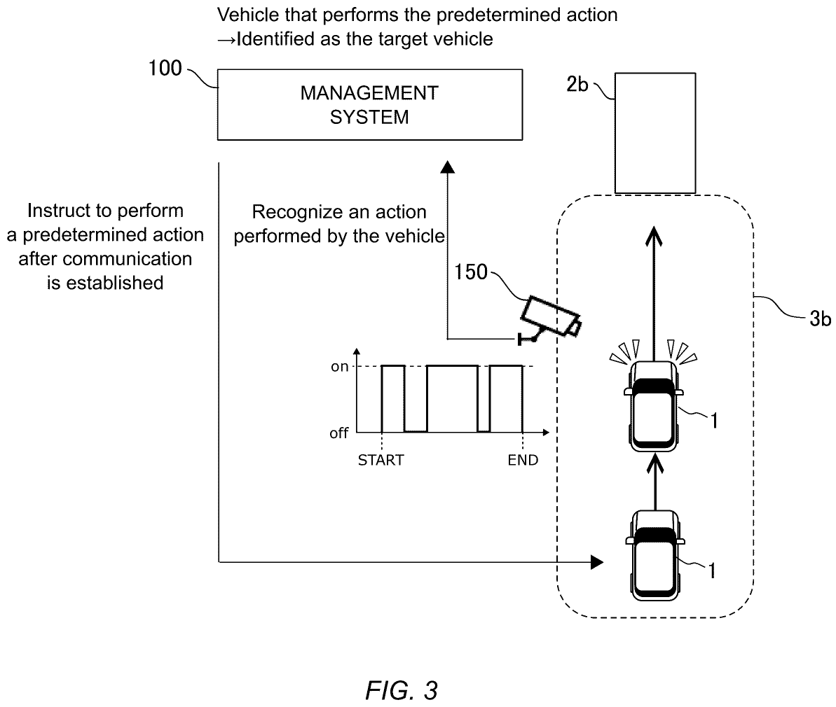

FIG. 3 is a conceptual diagram for explaining an outline of a vehicle identification process by the action-based identification method in the present embodiment. Here, the vehicle identification process by the action-based identification method uses communication between the management system 100 and the vehicle 1 as described below. That is, it is necessary that communication between the management system 100 and the vehicle 1 is established. Therefore, when the action-based identification method is employed, the vehicle identification zone 3b is set to be included in the authority transition zone 3a. After the communication is established, the management system 100 starts the vehicle identification process while the vehicle 1 (first vehicle) is traveling in the vehicle identification zone 3b.

When the vehicle identification process is started, the management system 100 first instructs the vehicle 1 to execute a predetermined action through communication. If vehicle 1 is a legitimate target vehicle, vehicle 1 is expected to execute a predetermined action in accordance with the instruction.

Next, the management system 100 recognizes an action executed by the vehicle 1 using the sensor 150. The management system 100 identifies the vehicle 1 that executes the predetermined action as the target vehicle. For example, when the predetermined action is flashing of the headlight, the management system 100 recognizes a flashing pattern from the detection information of the sensor 150. When the recognized pattern matches the operation pattern of the predetermined action, the management system 100 determines that the predetermined action has been executed, and identifies the vehicle 1 as the target vehicle.

In this way, in the present embodiment, the vehicle identification process by the action-based identification method can be executed. In the action-based identification method, it is necessary to detect an action of the vehicle 1 using the sensor 150. Therefore, the sensor 150 is configured to be able to detect at least an action to be executed by the vehicle 1. For example, in a case where a visually detectable visible action (an action related to the lighting of the lighting device, or the like) is executed, the sensor 150 is configured by a camera. Further, for example, in a case where an audible action (an action related to sounding of a horn, or the like) that can be detected aurally is executed, the sensor 150 is configured by a microphone.

The action-based identification method has advantages such as high flexibility, which can provide a degree of freedom in designing an action used for vehicle identification. On the other hand, in the action-based identification method, the vehicle 1 is required to execute an action having a certain duration, and thus a certain amount of time is required for vehicle identification. Therefore, when the vehicle identification process is performed by the action-based identification method, the effect of the present embodiment is more remarkable.

### 3. Additional Processing

The vehicle operation system according to the present embodiment can be configured to further execute processing described below.

### 3.1. Change of Vehicle Identification Zone in Accordance with Communication Quality

In the present embodiment, a case where the action-based identification method is adopted is considered. At this time, the management system 100 needs to communicate with the vehicle 1 in the vehicle identification process. Therefore, as described above, the management system 100 starts the vehicle identification process while the vehicle 1 is traveling in the vehicle identification zone 3b after the communication is established.

The position and range of the vehicle identification zone 3b are set as appropriate, and the effectiveness of the vehicle identification process is affected by the qualities of communication (for example, latencies are used as indicators). In particular, when the communication quality is deteriorated, the start of the vehicle identification process may be delayed from a normally expected situation. This is a factor that reduces the probability of success of the vehicle identification process.

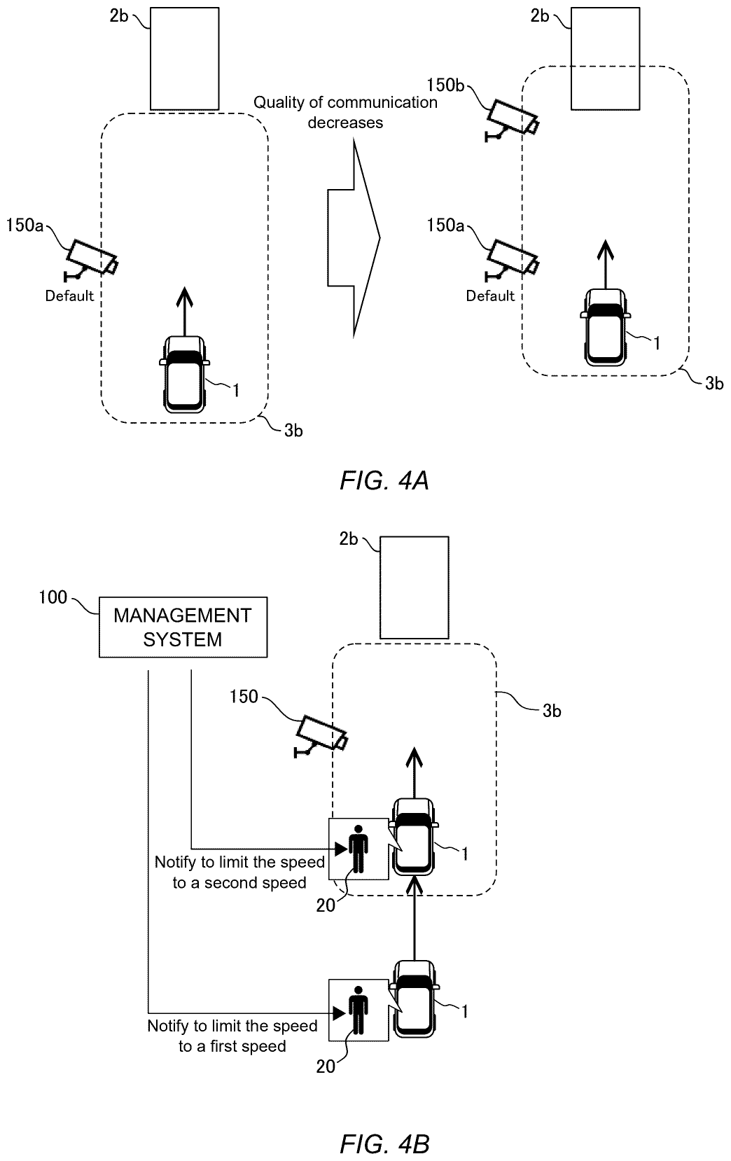

Therefore, the vehicle operation system according to the present embodiment can be configured to further execute a process of bringing the end position of the vehicle identification zone 3b closer to the vehicle stop position 2b. FIG. 4A is a conceptual diagram showing an outline of the processing.

For example, the management system 100 acquires information on communication qualities, and moves the position of the vehicle identification zone 3b closer to the vehicle stop position 2b as the communication qualities deteriorate (see FIG. 4A). The management system 100 may move the vehicle identification zone 3b in a stepwise manner by comparing the communication qualities with the threshold values, or may move the vehicle identification zone 3b continuously in accordance with the communication qualities. Alternatively, the management system 100 may expand the range of the vehicle identification zone 3b so that the end position approaches the vehicle stop position 2b. The management system 100 may move or extend the default vehicle identification zone 150a by using, for example, the default sensor 150b and another sensor 3b in combination in the vehicle identification process.

By executing the process in this way, the vehicle identification zone 3b can be changed in consideration of the delay in the start of the vehicle identification process. Thus, the probability of success of the vehicle identification process can be improved.

### 3.2. Notification of Vehicle Speed Limit

The vehicle identification process is generally performed using the sensor 150. Therefore, if the vehicle speed of the vehicle 1 is too high during the execution of the vehicle identification process, the accuracy of the vehicle identification process may be reduced.

Therefore, the vehicle operation system according to the present embodiment can be configured to further execute a process of notifying the user 20 to limit the speed of the vehicle 1 to a predetermined speed or less in accordance with the positional relationship between the vehicle 1 and the vehicle identification zone 3b. FIG. 4B is a conceptual diagram showing an outline of the processing.

One viewpoint of the process is to notify the user 20 that the speed of the vehicle 1 is limited to a predetermined speed (first speed) or less before the vehicle 1 arrives at the vehicle identification zone 3b. For example, when the vehicle 1 passes through a point a predetermined length before the vehicle identification zone 3b, the management system 100 notifies the user 20 that the speed of the vehicle 1 is limited to the first speed or less. After the communication with the vehicle 1 is established, the management system 100 may notify the user 20 of the information via the HMI of the vehicle 1, or may communicate with a user terminal (for example, a smartphone) and notify the user 20 of the information via the user terminal.

Another viewpoint of the process is to notify the user 20 that the speed of the vehicle 1 is limited to a second speed or less which is lower than the first speed after the vehicle 1 reaches the vehicle identification zone 3b. For example, when the vehicle 1 enters the vehicle identification zone 3b, the management system 100 notifies the user 20 that the speed of the vehicle 1 is limited to the second speed or less.

By executing the process in this way, it can be expected that the speed of the vehicle 1 is equal to or lower than the predetermined speed during the execution of the vehicle identification process. This makes it possible to appropriately ensure the accuracy of the vehicle identification process.

### 4. Processing Flow

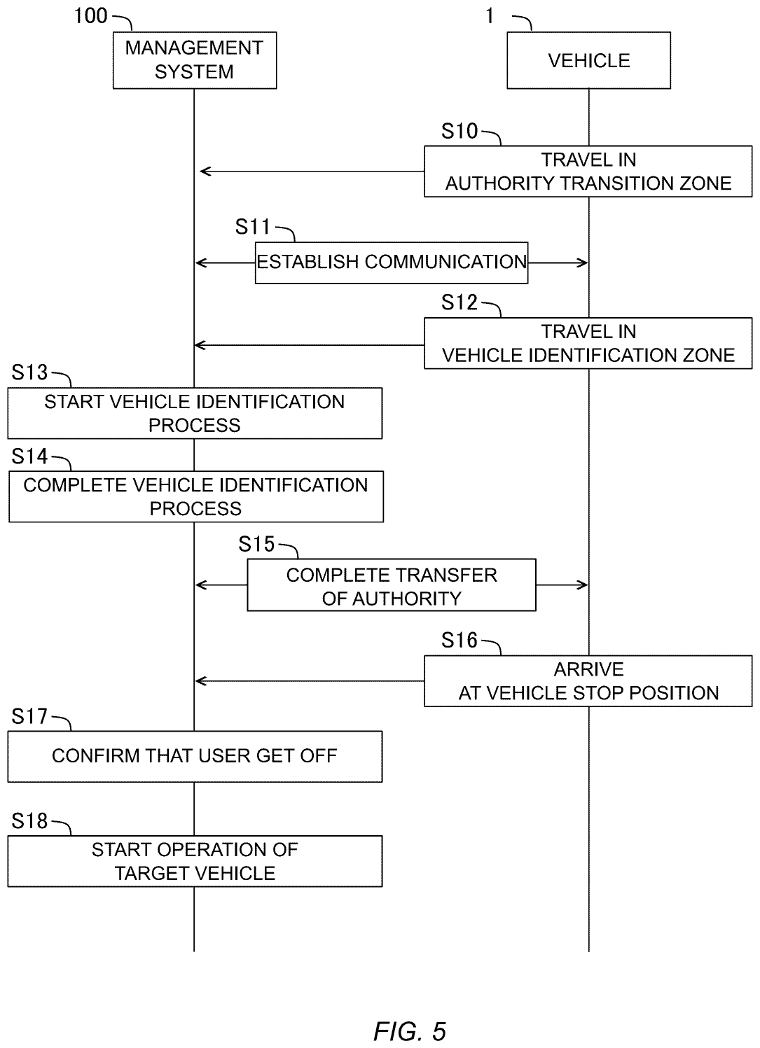

FIG. 5 is a diagram showing an example of a processing flow in the vehicle operation system according to the present embodiment.

First, the vehicle 1 travels in the authority transition zone 3a (step S10). Then, the management system 100 establishes communication with the vehicle 1 while the vehicle 1 is traveling in the authority transition zone 3a (step S11).

Next, the vehicle 1 travels in the vehicle identification zone 3b (step S12). Then, the management system 100 starts the vehicle identification process while the vehicle 1 is traveling in the vehicle identification zone 3b (step S13).

Next, after the completion of the vehicle identification process (step S14), the management system 100 completes the transfer of the operation authority from the user 20 (step S15).

Next, vehicle 1 (the target vehicle) arrives at the vehicle stop position 2b (step S16). Thereafter, the management system 100 confirms that the user 20 has gotten off the vehicle (step S17). For example, the management system 100 confirms that the user 20 has gotten out of the vehicle when the user 20 performs a predetermined completion action. Examples of the predetermined completion operation include the user 20 being away from the target vehicle by a predetermined distance or more, the user 20 locking the target vehicle, and the like.

After confirming that the user 20 has gotten out of the car, the management system 100 starts operating the target vehicle that is to stop at the vehicle stop position 2b.

### 5. Hardware Configuration

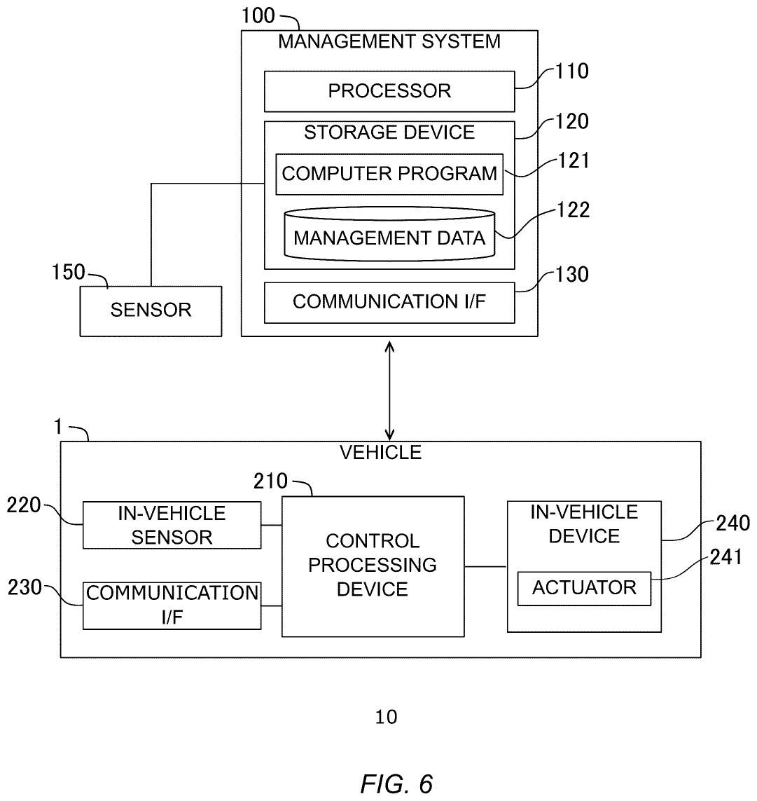

FIG. 6 is a diagram showing an example of a hardware configuration of the vehicle operation system 10 according to the present embodiment. The vehicle operation system 10 is configured between the vehicle 1 and the management system 100 that communicates with the vehicle 1. The vehicle operation system 10 includes a sensor 150 that is communicably connected to the management system 100.

The management system 100 includes a processor 110 (which may also be referred to as “processing circuitry”), a storage device 120, and a communication interface 130.

The processor 110 executes various processes. The processor 110 is configured by, for example, a central processing unit (CPU), a graphics processing unit (GPU), an application specific integrated circuit (ASIC), a field-programmable gate array (FPGA), or the like.

The storage device 120 is connected to the processor 110 and stores various kinds of information necessary for processing executed by the processor 110. The storage device 120 is configured by a recording medium such as a random access memory (RAM), a read only memory (ROM), a solid state drive (SSD), or a hard disk drive (HDD).

The storage device 120 stores a computer program 121 and management data 122.

The computer program 121 describes processing to be executed by the processor 110. The information processing by the management system 100 may be realized by cooperation between the processor 110 that executes the processing related to the computer program 121 and the storage device 120. In particular, information processing related to the transfer of the operation authority according to the present embodiment may be realized.

The management data 122 records various management information. For example, the management data 122 records management information (position, range, etc.) related to the authority transition zone 3a and the vehicle identification zone 3b, management information (communication qualities, first speeds, second speeds, etc.) related to the transition of the operation authority, management information (disposition, specifications, etc.) related to the sensor 150, management information (devices that execute actions, operation patterns, etc.) related to predetermined actions, and the like.

The communication interface 130 is an interface for communicating with an external device of the management system 100 to transmit and receive information. For example, the communication interface 130 is configured by a device for connecting to a peripheral device via a wireless LAN, a device for connecting to a moving body communication network, a device for connecting to the Internet, and the like. The management system 100 transmits and receives information to and from the vehicle 1 via the communication interface 130. The management system 100 may be configured to transmit and receive information to and from a user terminal (not illustrated) via the communication interface 130.

The vehicle 1 includes a control processing device 210, an in-vehicle sensor 220, a communication interface 230, and an in-vehicle device 240.

The control processing device 210 is communicably connected to the in-vehicle sensor 220, the communication interface 230, and the in-vehicle device 240. The control processing device 210 is a computer that performs information processing related to control of the vehicle 1 based on various kinds of information. The control processing device 210 may include a processor and a memory. Then, the information processing by the control processing device 210 may be realized by cooperation of the processor and the memory device.

For example, the control processing device 210 is configured by one or a plurality of electronic control units (ECUs). For example, the control processing device 210 may be configured as a kit (e.g., an AVP kit) for a function provided by the management system 100. The control processing device 210 generates and outputs a control signal for controlling the vehicle 1 by information processing. In particular, when the vehicle 1 receives an instruction to start execution of a predetermined action from the management system 100, the control processing device 210 generates and outputs a control signal for executing the predetermined action. The control signal is transmitted to the in-vehicle device 240.

The in-vehicle sensor 220 detects information on the surrounding environment and the traveling state of the vehicle 1. Examples of the in-vehicle sensor 220 include a camera, a radar, a LiDAR, a wheel speed sensor, an inertial measurement unit (IMU), and a global navigation satellite system (GNSS) sensor.

The communication interface 230 is an interface for communicating with a device outside the vehicle 1 to transmit and receive information. The vehicle 1 transmits and receives information to and from the management system 100 via the communication interface 230.

The in-vehicle device 240 includes a lighting device, an in-vehicle illumination device, a horn, a direction indicator, a wiper, a door, a door window, a driving device, a braking device, a steering device, an HMI, and the like. Each device of the in-vehicle device 240 includes an actuator 241 controllable by the control processing device 210. The in-vehicle device 240 acquires a control signal from the control processing device 210. The actuator 241 operates in accordance with the acquired control signal, and thus the control processing device 210 controls the in-vehicle device 240. The control of the vehicle 1 is realized by the control of the in-vehicle device 240.

What is claimed is:

1. A vehicle operation system for performing an operation of a target vehicle through communication by transferring an authority to operate the target vehicle from a user of the target vehicle, the vehicle operation system comprising processing circuitry configured to:
establish the communication with a first vehicle while the first vehicle is traveling in an authority transition zone prior to a vehicle stop position where the user gets off the target vehicle;
start a vehicle identification process for identifying the first vehicle as the target vehicle while the first vehicle is traveling in a vehicle identification zone prior to the vehicle stop position; and
after the vehicle identification process is completed, complete the transfer of the authority from the user.

2. The vehicle operation system according to claim 1, wherein
the vehicle identification zone is included in the authority transition zone, and
the vehicle identification process includes:
after the communication is established, instructing the first vehicle via the communication to perform a predetermined action for identifying the target vehicle;
recognizing an action performed by the first vehicle using a sensor; and
identify the first vehicle that performs the predetermined action as the target vehicle.

3. The vehicle operation system according to claim 2, wherein
the processing circuitry is further configured to move an end position of the vehicle identification zone closer to the vehicle stop position as quality of the communication decreases.

4. The vehicle operation system according to claim 1, wherein
the processing circuitry is further configured to notify the user to limit a speed of the first vehicle to a first speed or less before the first vehicle reaches the vehicle identification zone.

5. The vehicle operation system according to claim 4, wherein
the processing circuitry is further configured to notify the user to limit the speed of the first vehicle to a second speed or less after the first vehicle reaches the vehicle identification zone, the second speed being lower than the first speed.
